(19) United States
(12) Patent Application Publication
(10) Pub. No.: US 2012/0227678 A1
(43) Pub. Date: Sep. 13, 2012

(54) Multi-anchoring device incorporating a bearing system for tethering or securing articles such as animals, including, but not limited to a suction base

(76) Inventor: Carol Milani, Yuba City, CA (US)

(21) Appl. No.: 13/385,849

(22) Filed: Mar. 8, 2012

Related U.S. Application Data
(60) Provisional application No. 61/464,879, filed on Mar. 10, 2011.

(51) Int. Cl. A01K 15/04

(52) U.S. Cl. 119/712

(57) ABSTRACT

A multi-anchoring device incorporating a bearing for tethering or securing animals, including, but not limited to a suction base that can be secured on ground as well as hard surfaces. The inventive device includes a base, a ball joint with a bearing, and an eye-bolt. The base is comprised of plastic having multiple holes for securing it to the ground or hard surface. The ball joint is housed within the base and secures the eye bolt with the bearing for rotational properties for tethering the animal.

### CROSS-REFERENCE TO RELATED APPLICATION

This application claims priority under 35 USC Section 119(e) to co-pending U.S. provisional patent application No. 61/464,879, filed on Mar. 10, 2011, the disclosure of which is incorporated herein by reference in its entirety.

### FIELD OF THE INVENTION

The present invention relates generally to tethering device and more specifically it relates to a multi-anchoring device incorporating a bearing system for tethering or securing animals, including, but not limited to a suction base that can be secured on ground as well as hard surfaces.

### DESCRIPTION OF THE RELATED ART

It can be appreciated that a tethering device for animals has been in use for years. Typically, tethering devices for animals are comprised of rotatable elevated tether devices for use with retractable restraints, retracting leashes, rotating tether for securing an animal, retractable leash supports, rotary tethering systems, and animal tethering devices.

The following reflect the state of the art known to applicant and tendered with an acknowledged duty to divulge citations. It is stipulated that none teach singly, nor render obvious when considered in any permissible combination, the claimed invention:

U.S. Pat. No. 6,904,871

U.S. Pat. No. 6,612,263

U.S. Pat. No. 6,526,918

U.S. Pat. No. 6,523,500

U.S. Pat. No. 6,318,302

U.S. Pat. No. 6,314,916

While these devices may be suitable for the particular purpose to which they address, they are not as suitable for providing a safe and secure device for tethering animals that can be secured on ground as well as hard surfaces. The main problem with conventional tethering devices for animals is they do not have a way to anchor into hard surfaces and they are only secure using a mono anchor. Another problem is they do not incorporate a bearing system for a full proof system preventing entanglement. Also, another problem is most of them have a retractable tether that can harm animals.

In these respects, the multi-anchoring device incorporating a bearing for tethering or securing animals according to the present invention substantially departs from the conventional concepts and designs of the prior art, and in so doing provides an apparatus primarily developed for the purpose of provide a safe and secure device for tethering animals that can be secured on ground as well as hard surfaces that uses a bearing system.

### SUMMARY OF THE INVENTION

In view of the foregoing disadvantages inherent in the known types of tethering devices for animals now present in the prior art, the present invention provides a new multi-anchoring device incorporating a bearing system for tethering or securing animals, including, but not limited to a suction base construction wherein the same can be utilized to provide a safe and secure device for tethering animals that can be secured on ground as well as hard surfaces.

The general purpose of the present invention, which will be described subsequently in greater detail, is to provide a new multi-anchoring device incorporating a bearing system for tethering or securing animals, including, but not limited to a suction base that has many of the advantages mentioned heretofore and many novel features that result in a new multi-anchoring, bearing system tether for securing animals which is not anticipated, rendered obvious, suggested, or even implied by any of the prior art tether systems for animals, either alone or in any combination thereof.

To attain this, the present invention generally comprises a base, ball joint with bearing, and eye-bolt. The base is preferably made of plastic, having multiple holes for securing to ground or hard surfaces. The ball joint is housed within the base and secures the eye bolt and the bearing. The eye bolt is for attaching the leash or cable to the animal.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting. For example, while the device has been engineered for animals, it has utility in other areas, such as securing tarps, tents and other products that require reliable affixing to a substrate.

A primary object of the present invention is to provide a multi-anchoring device incorporating a bearing for tethering or securing animals that will overcome the shortcomings of the prior art devices.

Viewed from one vantage point, it is an object of the present invention to provide an anchoring device having means to attach said device to a substrate, said anchoring device including means to attach an object thereto.

An object of the present invention is to provide a multi-anchoring device incorporating a bearing for tethering or securing animals to provide a safe and secure device for tethering animals that can be secured on ground as well as hard surfaces.

Another object is to provide a multi-anchoring device incorporating a bearing for tethering or securing animals that tethers an animal in a safe and secure way without entanglement of the leash.

Another object is to provide a multi-anchoring device incorporating a bearing for tethering or securing animals that incorporates a bearing system for rotation.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is the complete unit showing the base, ball joint, and eye hook on its rotational plane.

FIG. 2 is an exploded parts perspective of FIG. 1.

FIG. 3 is a top plan view.

FIG. 4 is a side view.

FIG. 4A is a perspective view, looking down.

FIG. 5 is a sectional perspective view taken along a vertical plane bisecting FIG. 4.

FIG. 6 shows a perspective of a bearing which supports the ball joint.

FIG. 7 shows the unit with a suction cup base.

FIG. 8 shows the unit with a magnetic base.

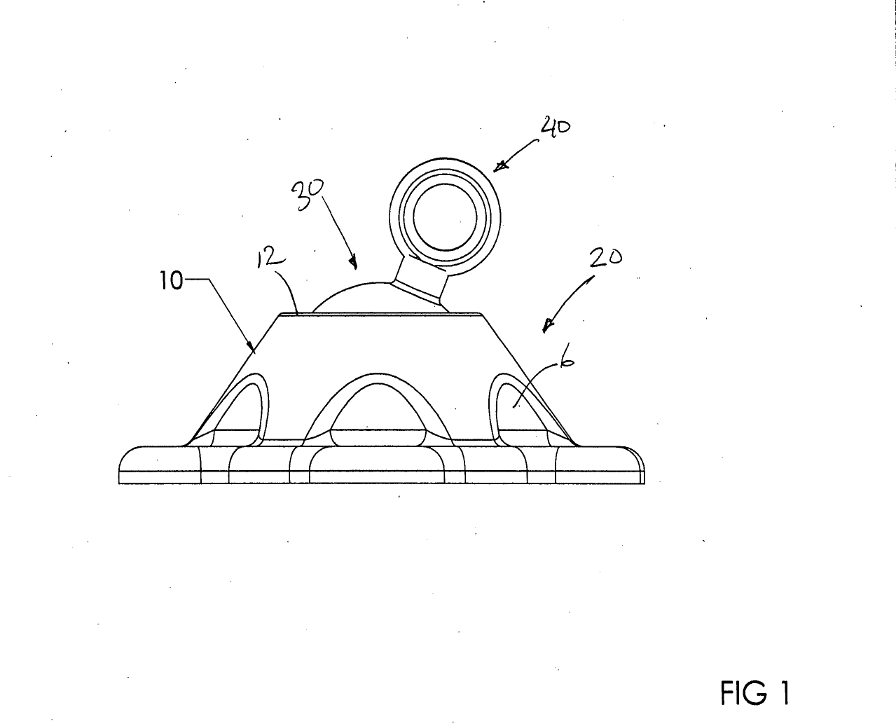

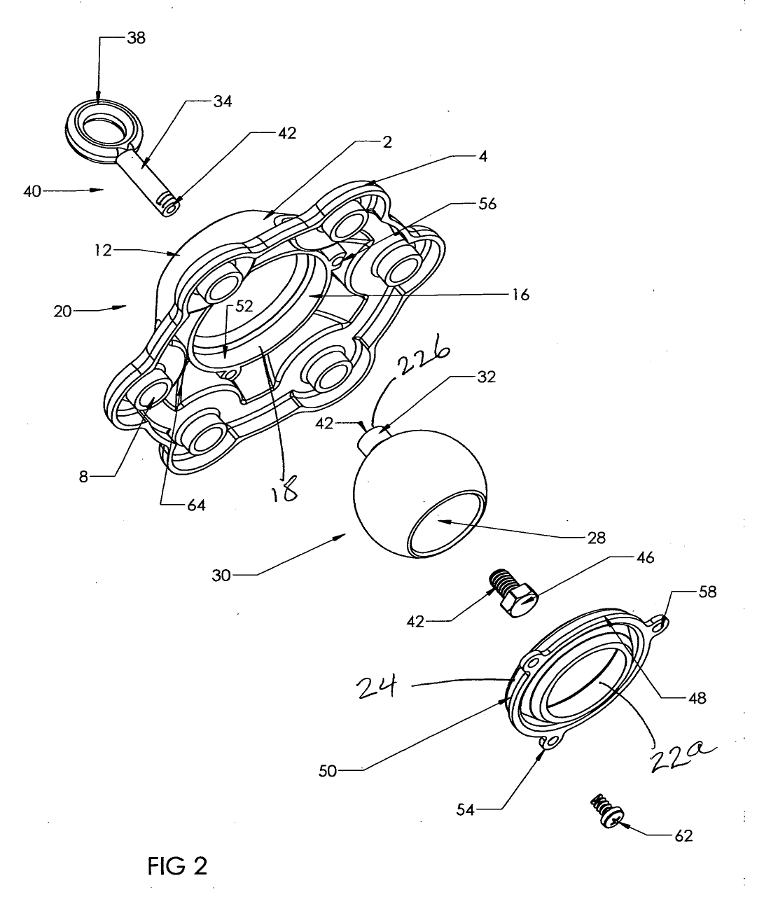

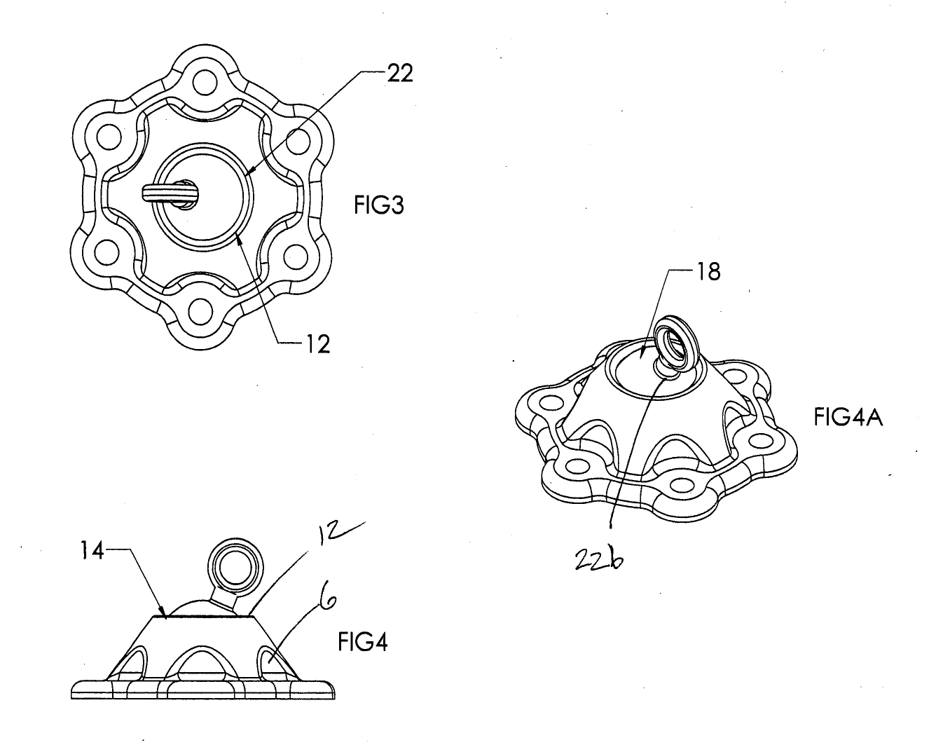

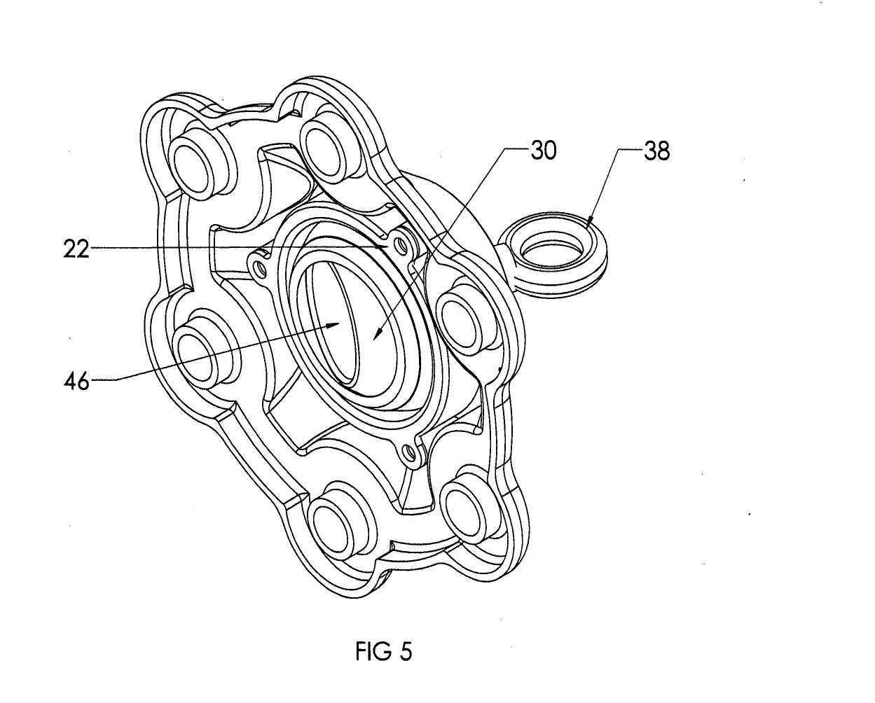

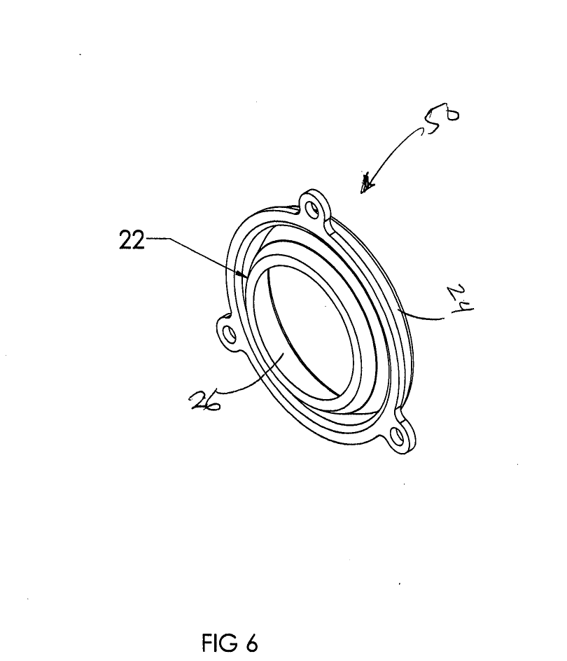

### DETAILED DESCRIPTION OF THE INVENTION

Turning now descriptively to the drawings, in which similar reference characters denote similar elements throughout the several views, the attached figures illustrate a multi-anchoring device 10 incorporating a bearing 22 for non-fouling tethering or securing animals, which comprise a base 20, ball joint 30 within the bearing 22, and an eye-bolt 40.

The base 20 may be plastic having multiple holes 8 for securing it to the ground or hard surfaces using tent stakes, lag bolts or other elongate fasteners. The holes 8 are provided on a flange 4 radiating from a bottom periphery of a hemispherical dome 2. The flange 4 provides a bottom surface (remote from eye bolt 40) for securing to an underlying substrate. Recessed relief areas 6 on the dome 2 and adjacent the holes 8 distort an otherwise true hemispherical shape, but provide clearance to accommodate the through passage of the fasteners.

The dome 2 is further modified by means of a truncated, planar top 12 to allow a top portion of the ball joint to project above the planar top 12 through a central opening 14 located on the top 12, thereby providing a greater range of motion for the ball joint 30. The ball joint 30 is housed in the base 20. The eye bolt 40 projects through the centrally disposed opening 14 located on the planar top 12 and is attached to the ball joint 30. The eye bolt 40 has a shaft 34 which projects above the base 20. The shaft 34 is attached to the ball joint 30 which is supported in the base 20 by means of the bearing 22a. The bearing 22 preferably has a cylindrical exterior 24 operatively coupled to a complementarily formed cavity 16 formed in an interior of the dome base 20. A rim 18, formed by the inner periphery of the central opening 14, retains the bearing 22a within the base 20.

The bearing has a cupped interior 26 (FIG. 6) complementally contoured to receive the substantially spherical ball joint 30, allowing the eye bolt 40 unimpeded conical precession above the base. The ball joint 30 features a central bore 28 to receive the shaft 34. A bearing sleeve 32 may be integrated into the top of the ball joint having either an interior thread 42 to receive threads 42 on an exterior of the shaft 34, or a stud 46 can fix the shaft 34 to the ball joint 30 by passing into the central bore 28 and engaging female threads 42 located in a hollow of shaft 34, remote from its end 38 which defines a closed loop free end 38. A further bearing 22b can be provided on the interior of bearing sleeve 32 for less friction. This bearing 22b is cylindrical having ball bearings between the shaft 34 and sleeve 32. The animal is thus attached to the eye bolt 40 by means of a leash or cable. The loop free end 38 can also be configured to thread into the shaft 34 at their juncture. The eyebolt 40 thus rotates about the axis defined by shaft 34 as well as precesses due to ball joint 30.

The plastic base has multiple holes 8 for securing it. The base 20 is comprised of a hard plastic material configured as a hemispherical dome 2. If the material for the dome and retaining plate 50 are judiciously selected, it can have bearing attributes, obviating the need for a separate bearing 22a, since the base 20 and retaining plate 50 would then have a low friction contact surface with the ball joint 30. There are perhaps six or more holes 8 along the bottom of the base for securing to hard surfaces or the ground. The base can be made of different materials, having different colors and logos for customization. The base can also be different shapes.

The ball joint 30 is thus housed within the base 20. The ball joint 30 resides within a mating interior of the bearing 22a which has a cylindrical exterior and is pressed or tightly fit sharply within the base 20. The bearing 22b supports the eye hook 30. The ball joint 30 can be made of different materials, having different colors for customization.

The ball joint 30 is constrained within the base 20 by means of a retaining plate 50. The cavity 16 has a bottom edge 52 along its periphery to receive the retaining plate 50. A circumscribing edge 48 of the retaining plate 50 registers with bottom edge 52 and ears 54 having holes 58 overlie fastener receivers 56 adjacent the bottom edge 52 to accommodate fasteners 62, shown here as threaded. The plate 50 may also have been dimensioned as a plug to frictionally reside within a lower portion of cavity 16. The interior of the dome 2 has relieved areas to avoid areas of thick plastic which increases cycle time when molding and includes webbing 64 so as to not compromise strength.

The eye bolt 40 is for tethering the animal. The eye bolt is a standard eye bolt preferably made of steel. The eye bolt can have different shapes.

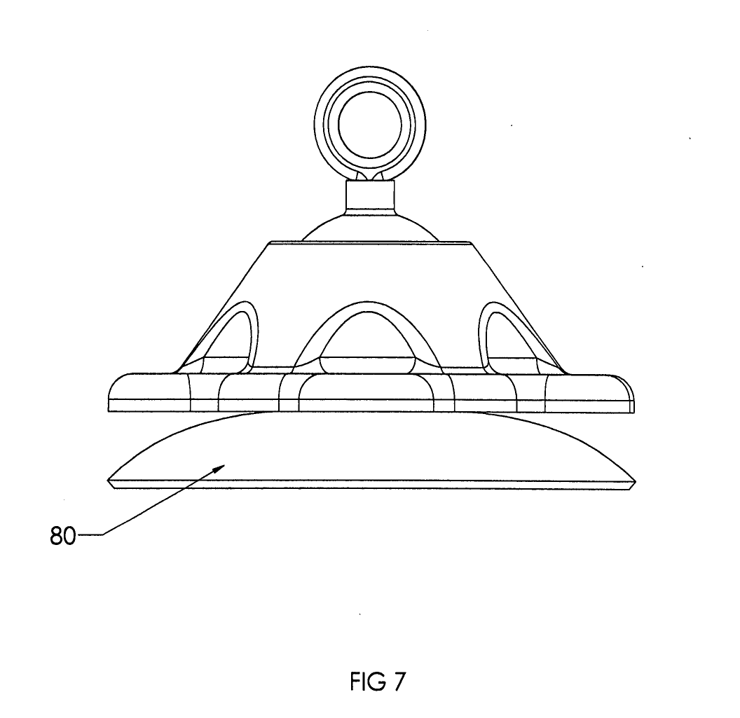

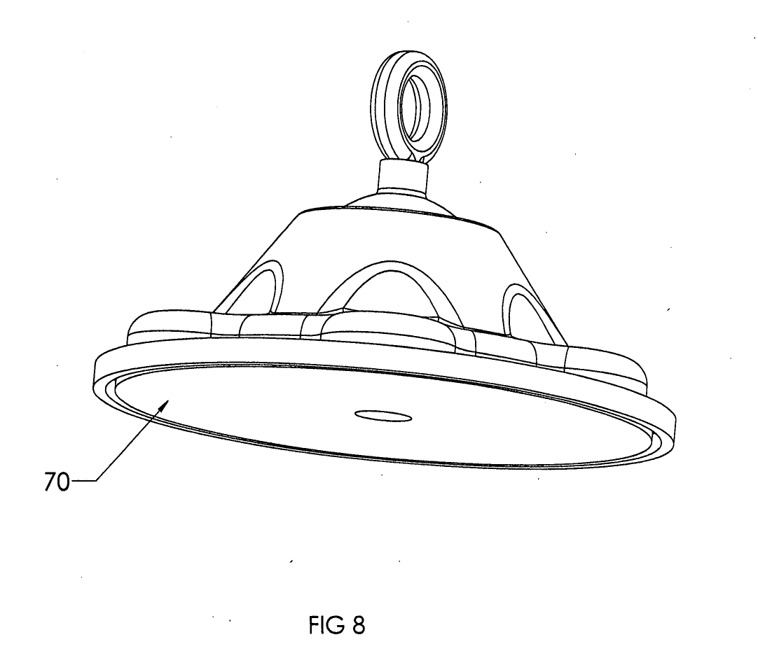

The eye bolt is connected to the ball joint 30 supported by bearing 22. The ball joint is then inserted into the base of the product and secured on the bottom of the base with a base retainer 50 having any color, size, shape. The base is secured to the ground by using tent stakes or to hard surfaces by using lag bolts. Where stakes and/or bolts are not feasible, a magnetic plate 70 (FIG. 7) or suction cup 80 (FIG. 8) can be attached. Either of these two alternatives would benefit from being integrated with the retaining plate 50 with access to the cavity 16 and fastener receivers 56 maintained for the fasteners 62. The user than secures the animal to the eye bolt by using the end of a leash or cable.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and mariner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and

Equivalents may be resorted to, falling within the scope of the invention

1. An anchoring device, comprising, in combination: a base, a ball joint residing within said base and an eye bolt connected to said ball joint and extending above a top of said base, such that said eye bolt enjoys unimpeded conical precession.

2. The device of claim 1 wherein said ball joint is fixed in said base by means of a retaining plate attached to the base and capturing said ball joint between said base and said retaining plate.

3. The device of claim 2 wherein said eye bolt includes a shaft held by said ball joint.

4. The device of claim 3 wherein said base includes a radiating flange extending from a lower periphery of said base.

5. The device of claim 4 wherein said radiating flange receives means for affixing said base to a substrate.

6. The device of claim 5 wherein said means for affixing said base is a suction cup located on said retaining plate on a side remote from said base.

7. The device of claim 5 wherein said means for affixing said base is a magnet located on said retaining plate on a side remote from said base.

8. The device of claim 2 wherein said retaining plate is substantially disc shaped and includes ears projecting radially from an edge of said disc, said ears including holes to receive fasteners configured to engage fastener receivers located on an interior of said base.

9. The device of claim 8 including a bearing interposed between said base and said ball joint to reduce rotational friction there between, said bearing having an interior hollowed cup to receive said ball joint.

10. The device of claim 9 wherein said base has a substantially hemispherical dome shaped contour with a truncated top having a central opening to receive a portion of said ball joint and said eye bolt there through

11. The device of claim 5 wherein the base includes relief areas to provide clearance for said affixing means on said radiating flange.
